(19) United States
(12) Patent Application Publication
(10) Pub. No.: US 2003/0057896 A1
(43) Pub. Date: Mar. 27, 2003

(54) Tracking tube with adapted tracking structure

(76) Inventors: Anthonie Hendrik Bergman, Eindhoven (NL); Hendrikus Bernardus Van Den Brink, Eindhoven (NL)

Correspondence Address: U.S. Philips Corporation, 580 White Plains Road, Tarrytown, NY, 10591, US

(21) Appl. No.: 10/233,455

(22) Filed: Sep. 3, 2002

(30) Foreign Application Priority Data
Sep. 6, 2001 (EP) 01203365.0

(51) Int. Cl. G09G 1/04

(52) U.S. Cl. 315/371

(57) ABSTRACT

The invention comprises a cathode ray tube of the index type having tracking structures (15,17) that comprise finger elements (15A, 17A). A width w_{P} of the finger element at the position P is dependent upon the position of P on the screen (10). This enables to compensate for a position dependent compromise between various parameters of the electron beams (7,8,9), thereby improving brightness and color purity of the tube. In a preferred embodiment the width w_{B} near the border of the screen (10) is larger than the width w_{C} near the center of the screen.

The invention relates to a cathode ray tube of the index type, the tube comprising means for generating at least one electron beam, means for deflecting the electron beam across an inner surface of a screen, tracking structures at the inner surface of the screen for deriving a positioning signal corresponding to the position of the beam on the screen, the tracking structures having finger elements extending substantially parallel to each other, each finger element having a width w, response means for controlling a deflection of the beam in response to the positioning signal, phosphor elements for generating light when being excited by the electron beam, the phosphor elements being positioned between the finger elements of the tracking structures.

A cathode ray tube of the index type is disclosed in WO 00/38212. As compared with the conventional cathode ray tube, in which the tube is provided with a color selection electrode (also referred to as shadow mask), such index tubes have the advantage that, due to the absence of the shadow mask, they have a lower weight, while the required energy is lower, and the sensitivity to vibrations and temperature differences is reduced. The principle of the “index” tube is based on the fact, that the inner surface of the screen is provided with two tracking structures for deriving a positioning signal corresponding to the position of the beam on the screen. The deflection of the beam is controlled in response to the positioning signal. Each of the two tracking structures comprises finger elements that extend substantially parallel to each other, preferably in the horizontal direction. The odd numbered finger elements are electrically connected to each other forming a comb-like structure. Likewise, the even numbered finger elements are connected together. Phosphor elements for generating light when being excited by the electron beam are positioned between (and partly overlapping with) an odd- and an even numbered finger element.

During operation of the tube the electron beam is deflected to follow the phosphor elements and deviation of this path is detected by the two finger elements, which flank each phosphor element above and below, as a difference in signal between the two comb-like structures. If the beam hits the upper finger element, it must be corrected downwards and vice versa.

The electron beam forms a spot on the screen. This spot falls partly on the phosphor element and partly on the flanking finger elements of the tracking structure.

The shape of the spot of the electron beam is elliptical, with the largest axis parallel to the horizontal (X-) direction and the smallest axis parallel to the vertical (Y-) direction. This is done to prevent the beam to hit wrong-color phosphor elements, which are located above and below the spot. A spot, which is too large in the Y-direction will cause color errors when it hits wrong-color phosphor elements as there is no shadow mask to prevent this. Hence, the spot size in the Y-direction is of importance for the color purity of the tube. As the beam is moved across the screen by a deflection field, which also acts as a lens, the distance of the gun to the screen is changed. Consequently, the dimensions of the spot change as a function of the position on the screen. Near the corners of the screen the spot deformation is largest, giving rise to spot-rotation and a deformation caused by the application of correction voltages known as DAF (Dynamic Astigmatism and Focus) voltages.

It is an object of the invention to provide a tracking system in which the possibilities are increased to compensate for spot deformations. The cathode ray tube according to the invention is characterized in that each finger element has a width w_{P} at a point P located on a central axis of the finger element, the width w_{P} of the finger element at a point P being dependent on the position of P on the screen.

The invention is based on the following recognitions.

The width w of the finger element in relation to the size and shape of the spot influences the brightness and the color purity of the light emitted by the tube. If the width w is small then a small spot is needed and the efficiency of the electrons is high as more electrons impinge on the phosphors rather than on the tracking fingers. However, for small w values the sensitivity of the tracking system to beam displacement is high. Furthermore, the electrical resistance of the tracking fingers increases, which is undesired as it increases the bandwidth of the tracking system.

On the other hand, if the width w is large then a larger spot is allowed, which is positive in view of the increased brightness of the display. However, as relatively more electrons impinge on the tracking fingers the efficiency diminishes. The tracking system is less sensitive to beam displacement, which is positive in view of the color purity of the tube. Further, the electrical resistance of the tracking fingers decreases.

The optimum width w of the tracking finger elements is a trade-off between the above mentioned items and depends inter alia upon the spot-size, brightness, color purity and demands on tracking accuracy.

In this situation the conventional tracking system does not give satisfactory results, since the constraints put on the width w of the tracking fingers in the center of the screen are different form those near the corners.

The tracking structure in accordance with the present invention has the advantage that the width of the tracking fingers can be optimized to the position on the screen.

This aspect as well as other aspects of the invention are defined by the independent claims.

Advantageous embodiments of the invention are defined in the dependent claims.

These and other aspects of the invention will be elucidated with reference to the embodiments described hereinafter.

In the drawings,

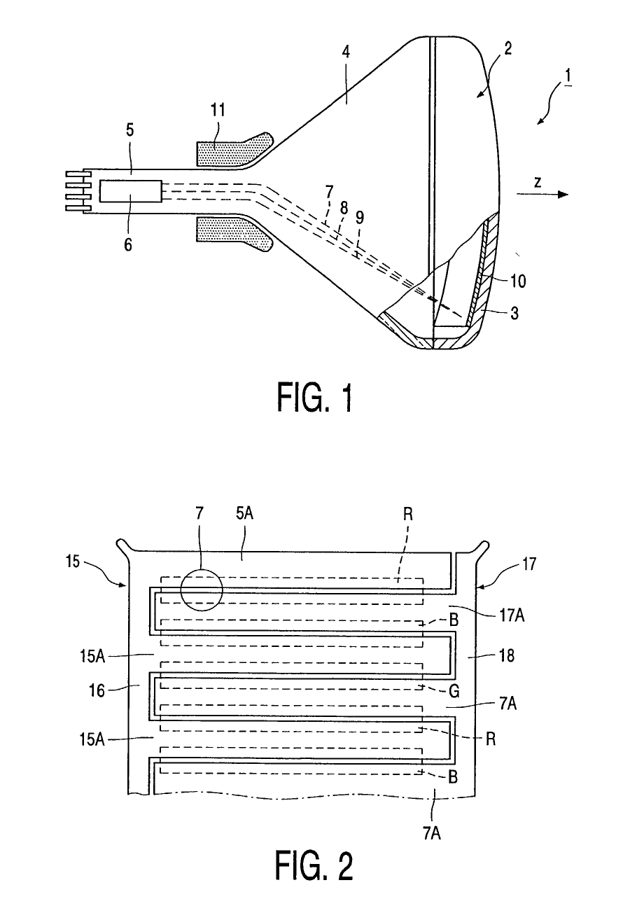

FIG. 1 shows diagrammatically a cathode ray tube,

FIG. 2 shows diagrammatically the tracking structure of a known index tube,

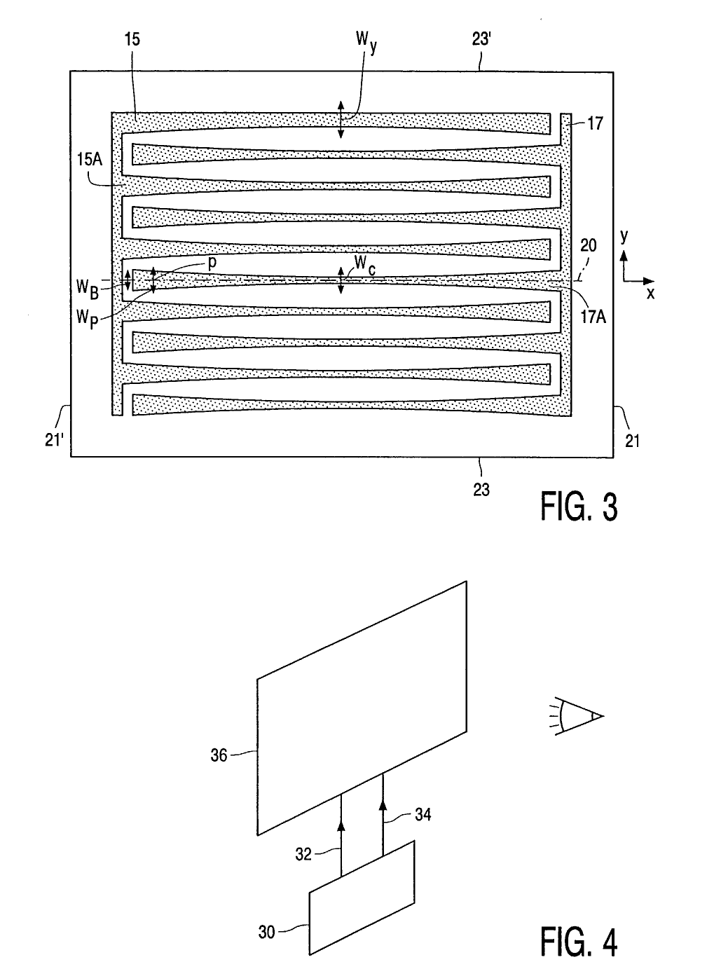

FIG. 3 shows an embodiment of the tracking structure according to the invention,

FIG. 4 shows a display apparatus according to the invention,

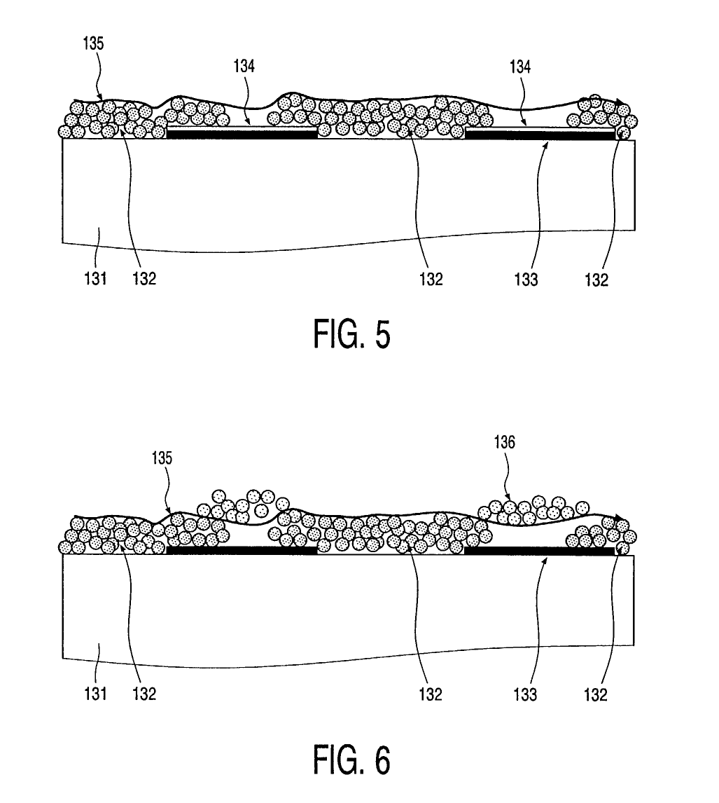

FIG. 5 shows a cross-section of a first tracking structure for deriving a tracking signal, and

FIG. 6 shows a cross-section of a second tracking structure for deriving a tracking signal.

The figures are not drawn to scale. In general, identical components are denoted by the same reference numerals in the figures.

The cathode ray tube shown in FIG. 1 is a color cathode ray tube 1 having an evacuated envelope 2 comprising a display window 3, a cone 4 and a neck 5. The neck 5 accommodates an electron gun 6 for generating three electron beams 7, 8 and 9 extending, in this embodiment, in one plane, the in-line plane. In the in-plane configuration, there are two side beams and one central electron beam. A display screen 10 comprises a plurality of red, green and blue-luminescing phosphor elements. Each group of (red, green or blue) phosphor elements forms a pattern. The display screen may alternatively comprise other patterns such as a black matrix or color filter patterns. On their way to the display screen 10, the electron beams 7, 8 and 9 are deflected across the display screen 10 by means of a deflection unit 11.

Although in FIG. 1 a three electron beam display is shown, the invention is not limited to such systems. The invention will also work in displays in which a different number of electron beams, e.g. one beam, is used.

FIG. 2 shows diagrammatically a detail of a known cathode ray tube of the index type. Two finger-shaped electrode elements 15 and 17 each partly overlap phosphor elements R, G and B. An electron beam 7 which impinges on, for example, phosphor element R will also impinge on electrodes 15 and 17. The electrodes have fingers 15A and 17A that preferably extend in the horizontal dimension and connection pieces 16 and 18 for electrically interconnecting the fingers 15A, 17A, in this way a comb-shape tracking structure is created. Between the screen and the tracking fingers 15A, 17A a black material is positioned, the so-called black matrix, which prevents unwanted stray light to escape towards the viewer of the display.

When the electron beam evenly impinges on finger elements 15 and 17, there will be no potential difference between the fingers. When the electron beam is shifted upwards or downwards, more electrons will impinge on one of the electrodes than on the other and a potential difference and/or difference of current through the fingers will occur between these fingers. This difference can be measured and used for correcting the position of the electron beam.

FIG. 3 shows an embodiment of the tracking structure according to the invention. The tracking structure comprises finger elements 15A,17A that extend in a X-direction (preferably the horizontal direction). The width of the finger element is the dimension of the finger element that extends in the Y-direction. w_{P} indicates the width at a point P, which is located on a central axis 20 of the finger element. The width is a function of the location of the point P on the screen. Since the width w_{P} is not constant but is a function of the position on the screen an additional freedom in the design of the tube is introduced to adapt the width to the local requirements on the tracking fingers. The requirements are in particular determined by spot-rotation and spot growth.

The screen 10 comprises first borders 21, 21′ that extend substantially perpendicular to the X-direction and the finger elements 15A, 17A extend in an X-direction. In an advantageous embodiment of the tracking system, the width W_{B} of the finger element close to a border is larger than a width w_{C} of the finger element in a center of the screen. Good results were obtained with a tracking system wherein WB≧1.1 w_{C}.

The screen 10 comprises second borders 23, 23′ that extend substantially parallel to the X-direction. In a further embodiment the width w_{Y} at the center of a finger element close to a second border 23, 23′ is larger than the width w_{C} of the finger element in the center of the screen. Good results were obtained with a tracking system wherein w_{Y}≧1.1 w_{C}.

In practice different tracking structures do occur in which the invention may be applied. FIGS. 5 and 6 show a cross-section of, respectively, a first and a second tracking structure for deriving a tracking signal. A glass substrate 131 is provided with black matrix elements 133 that shields unwanted stray radiation in the direction of a viewer. Between the black matrix elements 133 phosphor elements 134 are positioned. A reflecting layer 135 is located on top of the phosphor elements 134 for reflecting light inside the tube towards a viewer of the tube. The reflecting layer 135 is thin enough to allow the electrons of the electron beam to pass the layer and to excite the phosphor elements.

In the first tracking structure, shown in FIG. 5, electrically conductive tracking fingers 134 are positioned on top of the black matrix elements 133. When a tracking finger is hit by the electron beam a current difference is created within the tracking structure, which is used to derive a tracking signal.

In the second tracking structure, shown in FIG. 6, tracking phosphor elements 136 are positioned on the reflecting mirror 135 above the black matrix elements 133. When the electron beam hits a tracking phosphor element 136 light is generated. The generated light is recorded by optical detectors that are positioned within the tube and that generate a tracking signal.

It should be noted that the invention comprises, but is not limited to, finger elements that extend in the horizontal direction. The invention comprises also embodiments wherein the finger elements extend in the vertical direction.

A further aspect of the invention comprises a display apparatus comprising the cathode ray tube 36 according to the invention, and means 30 for providing control signals 32 and display signals 34 to the display device, as shown in FIG. 4.

In summary, the invention comprises a cathode ray tube of the index type having tracking structures 15,17 that comprise finger elements 15A, 17A. A width w_{P} of the finger element at the position P is dependent upon the position of P on the screen. This enables a position dependent compromise between various parameters of the electron beams 7,8,9, thereby improving brightness and color purity of the tube. In a preferred embodiment the width W_{B} near the border of the screen 10 is larger than the width w_{C} near the center of the screen.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of other elements or steps than those listed in a claim. The word “a” or “an” preceding an element does not exclude the presence of a plurality of such elements.

1. A cathode ray tube of the index type, the tube comprising:
means (6) for generating at least one electron beam,
means (11) for deflecting the electron beam across an inner surface of a screen (10),
tracking structures (15,17) at the inner surface of the screen (10) for deriving a positioning signal corresponding to the position of the beam on the screen, the tracking structures having finger elements (15A, 17A) extending substantially parallel to each other,
response means for controlling the deflection of the beam in response to the positioning signal,
phosphor elements (R,G,B) for generating light when being excited by the electron beam, the phosphor elements being positioned between the finger elements of the tracking structures,
wherein each finger element has a width w_{P} at a point P located on a central axis (20) of the finger element, the width w_{P} of the finger element at the point P being dependent on the position of P on the screen (10).

2. A cathode ray tube according to claim 1, wherein the finger elements (15A, 17A) extend in an X-direction, the screen (10) comprises first borders (21,21′) that extend substantially perpendicular to the X-direction, and wherein the width w_{B} of the finger element close to the first border is larger than a width w_{C} of the finger element in a center of the screen.

3. A cathode ray tube according to claim 2, wherein w_{B}≧11 w_{C}.

4. A cathode ray tube according to claim 1, wherein the finger elements (15A, 17A) extend in an X-direction, the screen (10) comprises second borders (23,23′) that extend substantially parallel to the X-direction, and wherein the width w_{Y} of the finger element close to the second border is larger than a width w_{C} of the finger element in a center of the screen.

5. A cathode ray tube according to claim 4, wherein w_{Y}>1.1 w_{C}.

6. A display apparatus, comprising:
the cathode ray tube (36) according to claim 1, and means (30) for providing control signals (32) and display signals (34) to the display device.
